(19) United States
(12) Patent Application Publication
(10) Pub. No.: US 2021/0209755 A1
(43) Pub. Date: Jul. 8, 2021

(54) AUTOMATIC LESION BORDER SELECTION BASED ON MORPHOLOGY AND COLOR FEATURES

(71) Applicants: Nabin K. Mishra, Overland Park, KS (US); Ravneet Kaur, San Jose, CA (US); Reda Kasmi, Bejaia (DZ); William V. Stoecker, Rolla, MO (US); Jason Hagerty, Waynesville, MO (US)

(72) Inventors: Nabin K. Mishra, Overland Park, KS (US); Ravneet Kaur, San Jose, CA (US); Reda Kasmi, Bejaia (DZ); William V. Stoecker, Rolla, MO (US); Jason Hagerty, Waynesville, MO (US)

(21) Appl. No.: 17/138,548

(22) Filed: Dec. 30, 2020

Related U.S. Application Data
(60) Provisional application No. 62/956,551, filed on Jan. 2, 2020.

(51) Int. Cl. G06T 7/00; G06T 7/11; G06K 9/46; G06T 7/90; G06K 9/62

(52) U.S. Cl. CPC G06T 7/0012; G06T 7/11; G06K 9/4604; G06T 2207/30096; G06K 9/6269; G06T 2207/20081; G06T 7/90

(57) ABSTRACT

Provided herein are classifying systems for classifying a lesion border of a dermoscopy image. Provided systems generally include an image analyzer that includes a border generator configured to automatically generate a plurality of borders based on a plurality of segmentation algorithms, wherein each of the plurality of borders is generated based on a different one of the plurality of segmentation algorithms; a feature detector configured to detect one or more features on the dermoscopy image for each of the plurality of borders; and a classifier configured to assign a classification to each of the plurality of borders based on the one or more features detected by the feature detector; wherein the image analyzer is configured to select a best border from the plurality of borders based on the classification assigned by the classifier. Also provided are methods for classifying a lesion border of dermoscopy images using the provided systems.

### CROSS REFERENCE TO RELATED PATENT APPLICATIONS

This application claims priority to U.S. Provisional Patent Application No. 62/956,551, filed on Jan. 2, 2020, the contents of which are hereby incorporated by reference in their entirety.

### BACKGROUND

An estimated 91,270 new cases of invasive melanoma have been diagnosed in 2018 in the United States, with an estimate of about 9,320 deaths resulting from melanoma. Using dermoscopy imaging, melanoma is fully visible at the earliest stages, when it is fully curable. Over a billion dollars per year is spent on biopsies of lesions that turn out to be benign, and even then, cases of melanoma are missed by dermoscopy domain experts. Dermoscopy increases the diagnostic accuracy over clinical visual inspection, but only after significant training. Hence automatic analysis of lesion dermoscopy has been an active area of research in recent years.

Skin lesion segmentation is the first step in any automatic analysis of a dermoscopy image. An accurate lesion segmentation algorithm is a critical step in conventional image processing for automated melanoma diagnosis. Numerous research papers have been published describing a variety of lesion segmentation algorithms. Each of those algorithms has its own advantages and disadvantages; each performing well on certain sets of images. But with the variety in skin color, skin condition, lesion type and lesion area, a single algorithm is not capable of providing the proper segmentation of a skin lesion every time.

### SUMMARY

Described herein are systems and methods that facilitate segmenting a dermoscopy image of a lesion to facilitate classification of the lesion. Generally, a dermoscopy image is received from an image source; pre-processed; and segmented. In some embodiments, segmenting the pre-processed dermoscopy image includes applying a thresholding algorithm to the dermoscopy image.

In a first example, provided herein is a classifying system for classifying a lesion border of a dermoscopy image, the system including an image analyzer having at least one processor that instantiates at least one component stored in a memory, the at least one component including: a border generator configured to automatically generate a plurality of borders based on a plurality of segmentation algorithms, wherein each of the plurality of borders is generated based on a different one of the plurality of segmentation algorithms; a feature detector configured to detect one or more features on the dermoscopy image for each of the plurality of borders; and a classifier configured to assign a classification to each of the plurality of borders based on the one or more features detected by the feature detector; wherein the image analyzer is configured to select a best border from the plurality of borders based on the classification assigned by the classifier.

In a second example, provided herein is a method for classifying a lesion border of dermoscopy images using a classifying system, including: receiving image from an image source; generating a plurality of borders based on a plurality of segmentation methods; extracting one or more features of the image for each of the plurality of borders; classifying each of the plurality of borders by assigning a classification to each of the plurality of borders based on the one or more features extracted; and selecting a best border from the plurality of borders based on the classification.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow diagram depicting an illustrative method of a border classifier, in accordance with embodiments of the disclosure.

FIG. 2A is a sample image showing a first target area for extraction of color features, in accordance with embodiments of the disclosure.

FIG. 2B is a sample image showing a second target area for extraction of color features, in accordance with embodiments of the disclosure.

FIG. 2C is a sample image showing a third target area for extraction of color features, in accordance with embodiments of the disclosure.

FIG. 2D is a sample image showing a fourth target area for extraction of color features, in accordance with embodiments of the disclosure.

FIG. 2E is a sample image showing a fifth target area for extraction of color features, in accordance with embodiments of the disclosure.

FIG. 3A is a sample dark corner image, in accordance with embodiments of the disclosure.

FIG. 3B is a sample dark corner mask image of the sample dark corner image of FIG. 3A, in accordance with embodiments of the disclosure.

FIG. 4A is a sample dark corner mask image, in accordance with embodiments of the disclosure.

FIG. 4B is a sample lesion border mask, in accordance with embodiments of the disclosure.

FIG. 4C is a sample common area after AND operation, in accordance with embodiments of the disclosure.

FIG. 4D is a sample effective lesion border mask, in accordance with embodiments of the disclosure.

FIG. 5A is a sample image depicting an exact border grading of an automatic border (dashed line) based on a manual border (solid line), in accordance with embodiments of the disclosure.

FIG. 5B is a sample image depicting an approximate border grading of an automatic border (dashed line) based on a manual border (solid line), in accordance with embodiments of the disclosure.

FIG. 5C is a sample image depicting an approximate border grading of an automatic border (dashed line) based on a manual border (solid line), in accordance with embodiments of the disclosure.

FIG. 5D is a sample image depicting a failing border grading of an automatic border (dashed line) based on a manual border (solid line), in accordance with embodiments of the disclosure.

FIG. 6 shows a Receiver Operating Characteristic (ROC) curve for subjective model for Case 1, Case 2, and Case 3 using a random forests border classifier, in accordance with embodiments of the disclosure.

FIG. 7 is a bar graph depicting classifier border method selection frequency, in accordance with embodiments of the disclosure.

FIG. 8 is a bar graph depicting border error comparison, in accordance with embodiments of the disclosure.

FIG. 9 is a block diagram of an illustrative digital dermoscopy system, in accordance with embodiments of the disclosure.

FIG. 10 is a flow diagram depicting an illustrative method of border classification using dermoscopy images, in accordance with embodiments of the disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein, or as indicated in the drawings, and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

### DETAILED DESCRIPTION

Segmentation of skin lesions is used in computer-aided diagnosis (CAD) of skin cancer. Segmentation determines a border or contour that separates the lesion from the surrounding skin, and the extraction and classification of clinical dermoscopy features, such as atypical pigment network and color, depends on the accuracy of segmentation. The contour is most commonly one picture element (pixel) wide, and is closed, completely enclosing a single undivided part of the image. The conventional goal of segmentation is to include, approximately, the skin lesion, specifically as much of the skin lesion as possible to the exclusion of surrounding skin. Success of segmentation of an image is traditionally measured by the two types of error involved: 1) the amount of the surrounding skin included within the border, measured in pixels within the image; and 2) the amount of the lesion not included within the border, measured in pixels within the image.

Inability of an individual lesion segmentation algorithm to achieve good lesion segmentation for all lesions leads to the idea of incorporating multiple lesion segmentation algorithms into a single system. An “ensemble of borders” using a weighted fusion has been found to be subject to error, such as in the presence of hair or bubbles. To overcome these obstacles, it may be beneficial to determine a combination of robust and efficient techniques that can achieve relatively accurate segmentation. Segmentation with acceptable lesion capture and tolerance may facilitate relatively accurate feature segmentation which, in turn, may facilitate increased classification accuracy.

As used herein, the term “dermoscopy” refers to a body imaging technique that involves viewing skin lesions with 8× or more magnification. The technique involves limiting surface reflectance through the use of, for example, a fluid, gel, mineral oil, or alcohol between the skin and a glass plate, or by using cross polarized light for illumination. The term “dermoscopy image” refers to a photograph of a skin lesion using a dermoscopy technique. In certain embodiments, the dermoscopy image is a digital image. Dermoscopy images may be acquired using any method known in the art, including but not limited to using a specialized dermoscopy imaging platform and inexpensive digital cameras, including cameras incorporated in a smartphone, with a dermoscopy-specific attachment or lens.

In various embodiments, a classifying system and/or a method of classifying provide a “best match” among a plurality of candidate segmentation algorithms for a given type of lesion and image, wherein the segmentation results may be improved over results obtained from a single segmentation technique or a weighted fusion of borders that can propagate errors. In certain embodiments, the classifying system and/or the method of classifying automatically select the best among the segmentations obtained from multiple algorithms. In some embodiments, the classifying system and/or the method of classifying solves the border selection problem. In various embodiments, the classifying system includes an automatic dermoscopy skin lesion border classifier, such as one configured to select the best lesion border among available choices for a skin lesion.

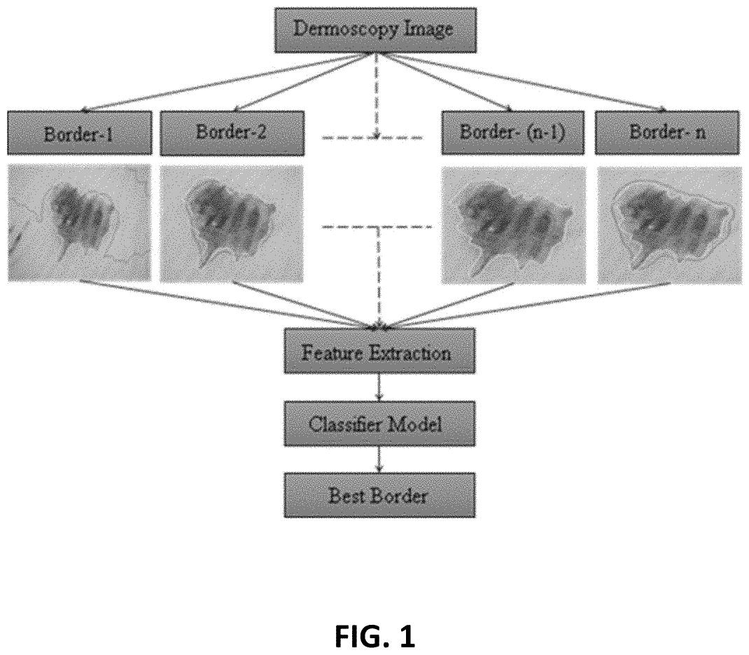

FIG. 1 is a flow diagram depicting a border classifier, in accordance with embodiments of the disclosure. In some embodiments, FIG. 1 depicts an automatic border classifier. The border classifier may use morphological and/or color features (e.g., from segmented border regions) to select the best of multiple border choices. In some embodiments, n in FIG. 1 equals to 13. As presented in FIG. 1., an automatic border (e.g., generated by the border classifier) is presented in dark red; whereas a manual border (e.g., selected by a specialist) is presented in light yellow.

In some embodiments, a classifying system (e.g., a classifier) and/or a classifying method for automatically selecting a lesion border for dermoscopy skin lesion images is provided, such as to aid in computer-aided diagnosis of melanoma. In some embodiments, the disclosed system and/or method help reduce or overcome the difficulty in segmentation of skin lesions owing to variation in traditional photographic techniques used to capture dermoscopy images. In some embodiments, the disclosed system and/or method provides an acceptable lesion border unachievable via traditional single-algorithm-based diagnosing systems and methods. In various embodiments, the disclosed system and/or method is configured to provide an acceptable lesion border for further processing of skin lesions

In various embodiments, the disclosed includes a system including a random forests border classifier model configured to select a lesion border from a plurality of (e.g., twelve) segmentation algorithm borders, such as graded on a “good-enough” border basis. In some embodiments, morphology and/or color features inside and outside an automatic border are used to help build the random forests border classifier model. In certain embodiments, disclosed includes a method including random forests border classifying using the random forests border classifier model.

In various embodiments, the classifying system of the instant disclosure automatically finds skin lesions better (e.g., higher in speed and/or accuracy) than a traditional classifying system using a single border algorithm. For example, the classifying system of the instant disclosure is able to predict a satisfactory border in 96.38% of cases when applied to an 802-lesion testing set. In comparison, a traditional classifying system using a single border algorithm detects a satisfactory border in only 85.91% of cases.

In some embodiments, the system and/or method of the instant disclosure relates to Image Analysis, Melanoma, Dermoscopy, Border, Lesion Segmentation, Skin Cancer, and/or Classifier.

### Lesion Segmentation Algorithms

In some embodiments, thirteen different segmentation algorithms are used to build a classifier model. In certain embodiments, the thirteen algorithms are implemented based on their performance on widely varying skin lesion images in a large and diverse image set.

A. Geodesic Active Contour (GAC) Segmentation

In certain embodiments, one or more (e.g., seven) of the border segmentation algorithms are based on the geodesic active contour (GAC) technique (U.S. Pat. No. 10,229,492 to Kasmi is incorporated herein by reference in its entirety for all purposes), and may be implemented using a level set algorithm. In some embodiments, the initial contour (e.g., of a GAC-based border segmentation algorithm) is found by Otsu segmentation of a smoothed image. In certain embodiments, the tendency of the Otsu segmentation method to find internal gradients is avoided by a series of filtering and convolution operations. In various embodiments, seven different pre-processing methods performed on the initial image using GAC and the level set algorithm yield seven borders. In some embodiments, the borders are labeled as GAC-1, GAC-2, GAC-3, GAC-4, GAC-5, GAC-6, and GAC-7.

B. Histogram Thresholding in Two Color Planes

In some embodiments, one or more (e.g., two) of the border segmentation algorithms are based on histogram thresholding. For example, histogram thresholding is applied separately on a smoothed blue color plane and on a pink-chromaticity image, providing two different lesion borders, named Histo-1 and Histo-2.

C. Histogram Thresholding via Entropy and Fuzzy Logic Techniques

In various embodiments, one or more (e.g., four) of the border segmentation algorithms are based on modified histogram thresholding. In some embodiments, the modified histogram thresholding method (e.g., of Huang and Wang) minimizes fuzziness measures in a dermoscopy skin lesion image. In some embodiments, the modified histogram thresholding method (e.g., of Li and Tam) is based on minimum cross entropy thresholding, where threshold selection minimizes the cross entropy between the dermoscopy image and its segmented version. In some embodiments, the modified histogram thresholding method (e.g., of Shanbhag) employs a modified entropy method for image thresholding. In some embodiments, the modified histogram thresholding method is based on the principal components transform (PCT) and the median split algorithm modeled on the Heckbert compression algorithm. For example, a RGB image is first transformed using the PCT and then a median split is performed on the transformed image to obtain the lesion border mask. In various embodiments, these four borders (e.g., obtained via modified histogram thresholding methods) are named Huang, Li, Shanbhag-2, and PCT. In some embodiments, one or more manually drawn border for each image is also used for training the classifier (e.g., the classifying system).

### Features of Classifier

In various embodiments, the lesion border classifier uses morphological features calculated from one or more candidate lesion borders and/or color features calculated from a dermoscopy image to identify the best border among the choices available. For example, nine morphological and forty-eight color-related features are used (e.g., by the classifier) in a method for classification.

A. Morphological Features

1. Centroid x and y Locations

In various embodiments, a centroid location is the location of a centroid of the area enclosed by the lesion border in terms of its x and y coordinates of the pixel location, origin at upper left corner of the image. Centroid location, in terms of x and y coordinates of a collection of n pixels {xᵢ, yᵢ} may be given by:

$$\begin{matrix}\overline{{X}_{c}} = \frac{1}{n} {\sum }_{i = 1}^{n} {x}_{i} & ( 1 ) \\ {\overline{Y}}_{c} = \frac{1}{n} {\sum }_{i = 1}^{n} {y}_{i} & ( 2 )\end{matrix}$$

where xᵢ is the x coordinate of the i^{th} pixel and yᵢ is the y coordinate of the i^{th} pixel.

2. Centroid Distance (D_{c})

In various embodiments, a centroid distance is the distance between the centroid of the image and the centroid of the lesion border. A centroid distance may be calculated as follows:

D_{c}=\sqrt{(x_{c,lb} −x_{c,im})²+(y_{c,lb}−y_{c,im})²} (3)

3. Lesion Perimeter (LP)

In some embodiments, a lesion perimeter is calculated by counting the outermost pixels of the lesion.

4. Lesion Area (LA)

In some embodiments, a lesion area is calculated by counting the number of pixels inside the lesion border.

5. Scaled Centroid Distance (SDc)

In some embodiments, a scaled centroid distance is the ratio of centroid distance (D_{c}) to the square root of lesion area:

$$S {D}_{c} = \frac{{D}_{c}}{\sqrt{L A}} \qquad ( 4 )$$

6. Compactness (C)

In some embodiments, compactness is defined as the ratio of the lesion perimeter to the square root of 47 times the lesion area. In certain embodiments, a circle has unity compactness. Compactness may be calculated as follows:

$$C = \frac{L P}{\sqrt{4 * π * L A}} \qquad ( 5 )$$

7. Size (mm)

In some embodiments, size is recorded in mm and may be obtained from medical record (e.g., of a patient).

8. Size Ratio

In some embodiments, size ratio is calculated as follows:

$$Size ratio = \frac{size ( mm )}{2 \sqrt{LA / π}} \qquad ( 6 )$$

B. Color Features

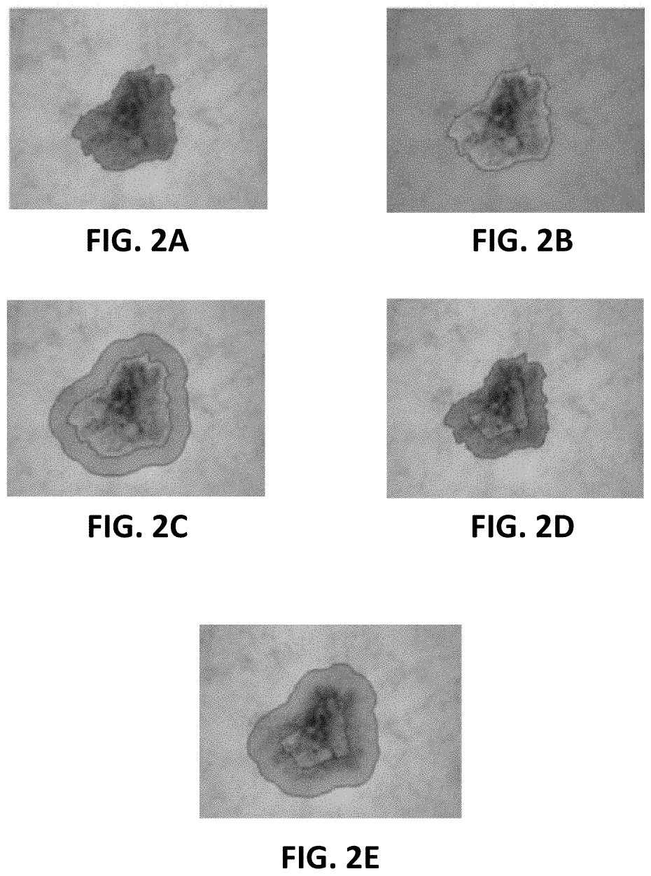

In various embodiments, color features are calculated separately from different target areas in the image, defined with an intention to identify color difference between the inside and outside of the lesion (e.g., as shown in FIG. 2). In some embodiments, rim target areas are calculated by the distance transform of the binary lesion border image. In certain embodiments, empirically optimized parameters for rim and corner sizes are given in terms of the parameter d. In some embodiments, the optimized value of d is 50 for 1024×768 images. In certain embodiments, the value of d is proportional to image size.

In accordance to various embodiments, FIG. 2 show target areas for extraction of color features. For example, extracted color features are highlighted with gray overlay. FIG. 2A is a sample image showing a first target area for extraction of color features, in accordance with embodiments of the disclosure. FIG. 2B is a sample image showing a second target area for extraction of color features, in accordance with embodiments of the disclosure. FIG. 2C is a sample image showing a third target area for extraction of color features, in accordance with embodiments of the disclosure. FIG. 2D is a sample image showing a fourth target area for extraction of color features, in accordance with embodiments of the disclosure. FIG. 2E is a sample image showing a fifth target area for extraction of color features, in accordance with embodiments of the disclosure.

1. Inside Lesion Area

In some embodiments, the inside lesion area is or includes the area inside the lesion border and may be equal to the lesion area (LA) (e.g., as shown in FIG. 2A). In certain embodiments, the first target area is or includes the inside lesion area.

2. Outside Lesion Area

In some embodiments, the outside lesion area is or includes the area of the image outside the lesion border (e.g., as shown in FIG. 2B). In various embodiments, if the lesion area covers the entire image, then the outside lesion area equals to zero and all the color features in the outside lesion area are zero. In certain embodiments, the second target area is or includes the outside lesion area.

3. Rim Area Outside Lesion Border (e.g., Outer Rim Area)

In some embodiments, the rim area outside lesion border is or includes the area just outside (e.g., proximal to the lesion border) the lesion border (e.g., as shown in FIG. 2C). In certain embodiments, a distance transform matrix is used to select pixels in this region. For example, pixels not in the LA that are within d√̅2(≈70.71) pixels from the border are included in this region. In certain embodiments, the third target area is or includes the rim area outside lesion border. In some embodiments, the rim area outside lesion border may also be referred to as the outer rim area.

4. Rim Area Inside Lesion Border (e.g., Inner Rim Area)

In some embodiments, the rim area inside lesion border is or includes the area just inside (e.g., proximal to the lesion border) the lesion border (e.g., as shown in FIG. 2D). In certain embodiments, a distance transform matrix is used to select pixels in this region. For example, pixels in the LA that are within d√̅2(≈70.71) pixels from the border are included in this region. In certain embodiments, the fourth target area is or includes the rim area inside lesion border. In some embodiments, the rim area inside lesion border may also be referred to as the inner rim area.

5. Overlapping Rim Area at Lesion Border

In some embodiments, the overlapping rim area is or includes areas just inside and just outside the lesion boundary or border (e.g., as shown in FIG. 2E). For example, pixels in the LA that are within 0.75*d√̅2(≈53.03) pixels from the border and pixels not in the LA that are within 0.75*d√̅2(≈53.03) pixels are included in this region. In certain embodiments, the fifth target area is or includes the overlapping rim area.

C. Removal of Dark Corners

In various embodiments, dark corners (e.g., of an image to be segmented) are excluded from calculation of color features. In certain embodiments, a dark corner is defined as a region, such as within a distance of 5d pixels from an image corner, where intensity value of a grayscale image (of the image to be segmented) is less than 1.5d. In various embodiments, a dark corner threshold is determined by histogram analysis of samples with dark corners in the training set images and/or testing set images. In some embodiments, all holes in the dark corner region are filled.

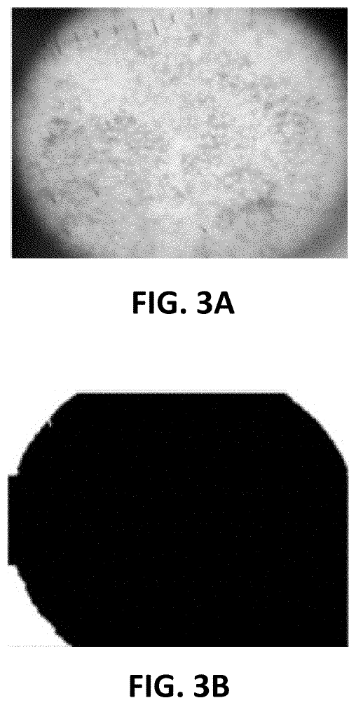

FIG. 3A is a sample dark corner image (e.g., with three dark corners), in accordance with embodiments of the disclosure. FIG. 3B is a sample dark corner mask (e.g., shown in white) image of the sample dark corner image of FIG. 3A, in accordance with embodiments of the disclosure.

In some embodiments, a dark corner mask is ANDED with an original border mask (e.g., automatically generated by the system before the ANDED operation) to calculate the color features excluding the dark corners. Dark corner areas of an image may be artifacts of dermatoscope optics, such as from zooming of the lens (e.g., zooming out). In various embodiments, the ANDED operation is carried out as in (7) and (8).

M_{commA}=M_{dc}∧M_{region} (7)

M_{effR}= [symbol] _{commA}∧M_{region} (8)

where, M_{dc} is a dark corner mask, M_{region} is a region mask (e.g., the inside lesion area, the outside lesion area, the outer rim area, the inner rim area, or the overlapping rim area), M_{commA} represents the common area between the dark corner area and the selected area/region, M_{effR} is the effective region mask, ∧ represents the logical AND operation and ¬ represents the logical NOT operation.

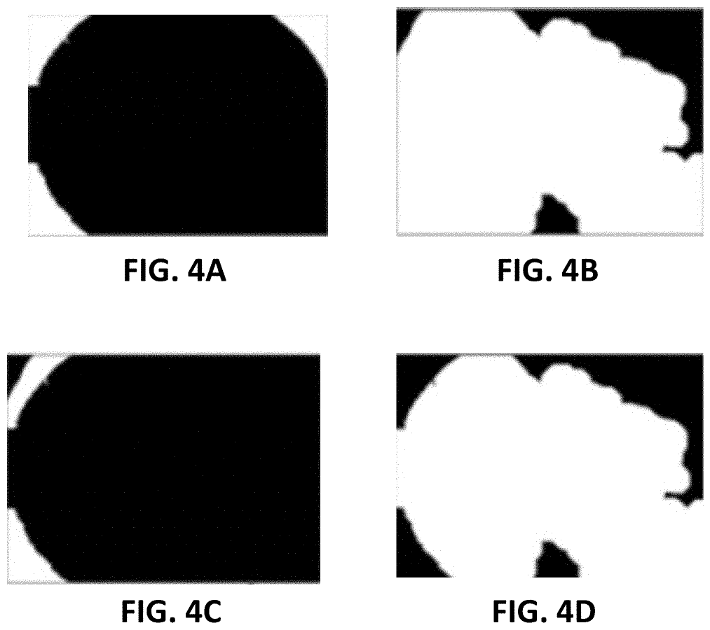

In certain embodiments the ANDED operation applied to an image is shown in FIGS. 4A-4D. FIG. 4A is a sample dark corner mask image, in accordance with embodiments of the disclosure. FIG. 4B is a sample lesion border mask, in accordance with embodiments of the disclosure. FIG. 4C is a sample common area after AND operation, in accordance with embodiments of the disclosure. FIG. 4D is a sample effective lesion border mask, in accordance with embodiments of the disclosure.

D. Color Plane Calculations

In various embodiments. operations in (7) and (8) are performed for all five regions, namely the inside lesion area, the outside lesion area, the outer rim area, the inner rim area, or the overlapping rim area (e.g., as shown in FIGS. 2A-2E). In some embodiments, the color features are calculated for these five regions and may include one or more of the following color features:

1. Mean Intensity of Red, Green and Blue Color Planes for each Effective Region

In some embodiments, mean intensity of red, green and blue color planes may be calculated by having the red, green and blue intensity planes from a dermoscopy image ANDED with individual effective region masks (e.g., the inside lesion area, the outside lesion area, the outer rim area, the inner rim area, or the overlapping rim area). In various embodiments, the calculations of mean intensities of red, green, and blue color planes are carried out as in (9), (10), and (11), respectively:

$$\begin{matrix}\overline{{R}_{e f f R}} = \frac{1}{N} {\sum }_{i = 1}^{N} {I}_{r e d} ( i ) & ( 9 ) \\ \overline{{G}_{e f f R}} = \frac{1}{N} {\sum }_{i = 1}^{N} {I}_{g r e e n} ( i ) & ( 10 ) \\ \overline{{B}_{e f f R}} = \frac{1}{N} {\sum }_{i = 1}^{N} {I}_{b l u e} ( i ) & ( 11 )\end{matrix}$$

where I_{red}, I_{green} and I_{blue} represent the intensity of red, green and blue color planes, respectively, and N represents the total number of pixels in the effective region.

2. Intensity Standard Deviation of Red, Green and Blue Planes for each Effective Region

In some embodiments, the intensity standard deviation is calculated using the mean intensity of each color plane for each effective region. The calculations of intensity standard deviation of red, green and blue planes for each effective region may be carried out as in (12), (13) and (14), respectively.

$$\begin{matrix}s t d {R}_{e f f R} = \sqrt{\frac{1}{N - 1} {\sum }_{i = 1}^{N} {( {I}_{r e d} ( i ) - \overline{{R}_{e f f R}} )}^{2}} & ( 12 ) \\ {stdG}_{e f f R} = \sqrt{\frac{1}{N - 1} {\sum }_{i = 1}^{N} {( {I}_{g r e e n} ( i ) - \overline{{G}_{e f f R}} )}^{2}} & ( 13 ) \\ {stdB}_{e f f R} = \sqrt{\frac{1}{N - 1} {\sum }_{i = 1}^{N} {( {I}_{b l u e} ( i ) - \overline{{B}_{e f f R}} )}^{2}} & ( 14 )\end{matrix}$$

where I_{red}, I_{green} and I_{blue} represent the intensity of red, green and blue color planes, respectively. R̅_̅{̅e̅f̅f̅R̅}̅, G̅_̅{̅e̅f̅f̅R̅}̅ and B̅_̅{̅e̅f̅f̅R̅}̅ represent the mean intensity of red, green and blue planes, respectively, for the effective region. N represents the total number of pixels in the effective region.

3. Mean Intensity and Standard Deviation of a Luminance Image

In some embodiments, a luminance image is calculated by equation (15), whereas mean intensity and standard deviation of the luminance image are calculated by equations (16) and (17), respectively.

$$\begin{matrix}{I}_{g r a y} ( r , c ) = 0.2989 * {I}_{r e d} ( r , c ) + 0.5870 * {I}_{g r e e n} ( r , c ) + 0.1140 * {I}_{b l u e} ( r , c ) & ( 15 ) \\ \overline{Gra {y}_{e f f R}} = \frac{1}{N} {\sum }_{i = 1}^{N} {I}_{g r a y} ( i ) & ( 16 ) \\ {stdGray}_{e f f R} = \sqrt{\frac{1}{N - 1} {\sum }_{i = 1}^{N} {( {I}_{g r a y} ( i ) - \overline{Gra {y}_{e f f R}} )}^{2}} & ( 17 )\end{matrix}$$

4. Difference of the Mean Intensity of Outer and Inner Border Rims

In some embodiments, the difference of the mean intensities is an absolute difference between the mean intensities of the two rims for each RGB color plane and the grayscale image.

5. Difference of the Standard Deviations of Outer Inner Border Rims

In some embodiments, the difference of the standard deviations is an absolute difference between standard deviations of the two rims for each RGB color plane and the grayscale image.

Implementation of System and/or Method

A. Image Database

In some embodiments, the classifying system is trained with a plurality of dermoscopy images (e.g., 833) and tested with a disjoint testing set of dermoscopy images (e.g., 802 of them). In some embodiments, a method of classifying includes training a classifying system with a plurality of dermoscopy images and testing the system with a disjoint testing set of dermoscopy images. For example, the dermoscopy images may be obtained from clinics (e.g., four clinics from 2007-2009 as part of NIH SBIR dermoscopy studies R43 CA153927-01 and CA101639-02A2). The dermoscopy images may be acquired via cameras (e.g., DSC-W70 of Nikon®) and/or dermatoscopes (e.g., DermLite® Fluid of 3Gen LLC). The dermoscopy images may be reduced to a common resolution of 1024×768 pixels.

B. Segmentation Algorithm Processing

In some embodiments, the system is configured so that each image (e.g., of the plurality of dermoscopy images) is processed multiple times, each time by a different one of the plurality of segmentation algorithms (e.g., by one of GAC-1, GAC-2, GAC-3, GAC-4, GAC-5, GAC-6, GAC-7, Histo-1, Histo-2, Huang, Li, Shanbhag-2, and PCT). In some embodiments, each image processing performed by the system generates zero to multiple borders, and may be generated based on size and/or location filters implemented in the algorithm. For example, a plurality of automatic borders (e.g., 12,452 automatic borders) may be automatically generated by the system by processing a plurality of images (e.g., 833 images), which may then be assessed based on a plurality of manual lesion borders (e.g., 833 manual borders) drawn, selected, and/or validated by a specialist (e.g., a dermatologist).

C. Subjective Border Grading System

In some embodiments, the system is configured to recognize relative border accuracy and border inclusiveness. In certain embodiments, the system is configured for each border to be assigned with a border grade. In various embodiments, each border (e.g., a training border or a test border) is manually rated by one or more analyzers (e.g., human analyzers), such as by two or more analyzers, such as by a first analyzer (e.g., a dermatologist) and a second analyzer (e.g., a student) to achieve a consensus border grade. In various embodiments, the assignable border grades include: Exact, Approximate, and Failing. In certain embodiments, each of the assignable border grades corresponds to a border score (e.g., zero, one, or two). In certain embodiments, an automatic border assigned with a border grade of exact, which may be referred to as an exact border, may substantially match (e.g., with minute differences) a corresponding manual border. In certain embodiments, an automatic border assigned with a border grade of approximate, which may be referred to as an approximate border, may capture all essential diagnostic features (e.g., that are diagnosable by a human analyzer). In certain embodiments, an automatic border assigned with a border grade of failing, which may be referred to as a failing border, may miss one or more essential diagnostic features (e.g., border being too small) or include too much non-lesion area (e.g., border being too large).

In some embodiments, the classifying system (e.g., a classifier model) is configured to account borders rated as Exact or “2” as good borders and to account borders rated as Failing or “0” as bad borders. In some embodiments, the system is able to automatically produce less than 0.5% (e.g., 0.37%) of failed borders and produce more than 99% (e.g., 99.63%) of good enough borders (e.g., exact or approximate).

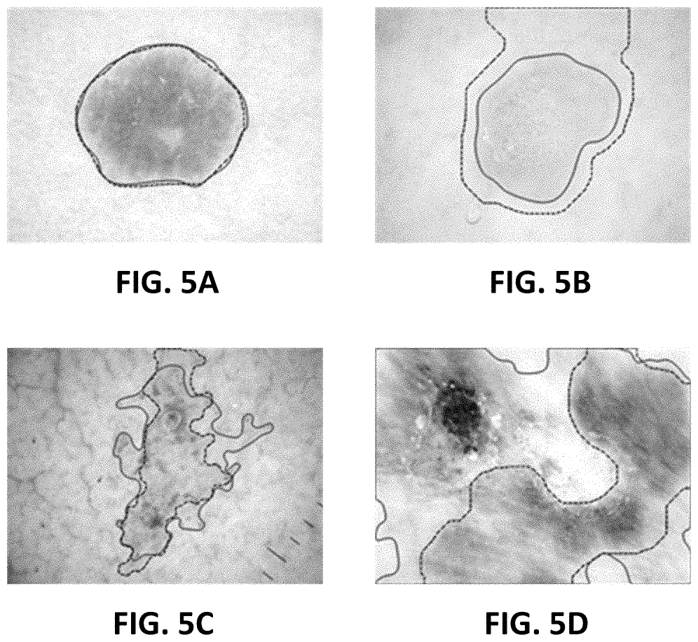

FIG. 5A is a sample image depicting an exact border grading of an automatic border (dashed line) based on a manual border (solid line), in accordance with embodiments of the disclosure. FIG. 5B is a sample image depicting an approximate border grading of an automatic border (dashed line) based on a manual border (solid line), in accordance with embodiments of the disclosure. FIG. 5C is a sample image depicting an approximate border grading of an automatic border (dashed line) based on a manual border (solid line), in accordance with embodiments of the disclosure. FIG. 5D is a sample image depicting a failing border grading of an automatic border (dashed line) based on a manual border (solid line), in accordance with embodiments of the disclosure. In some embodiments, the system is configured to consider approximate borders (e.g., of FIG. 5B and FIG. 5C) considered good enough (e.g., by a human analyzer).

D. Classifiers Developed for Three Training Cases

In some embodiments, the system is configured to consider one or more of the border scores (e.g., 0, 1, 2) in the building of a classifier model of the system. In some embodiments, each image of the training set of images and of the testing set of images may be processed, analyzed, or diagnosed by calculating a plurality of features (e.g., 57 features) including one or more morphological features and/or one or more color features.

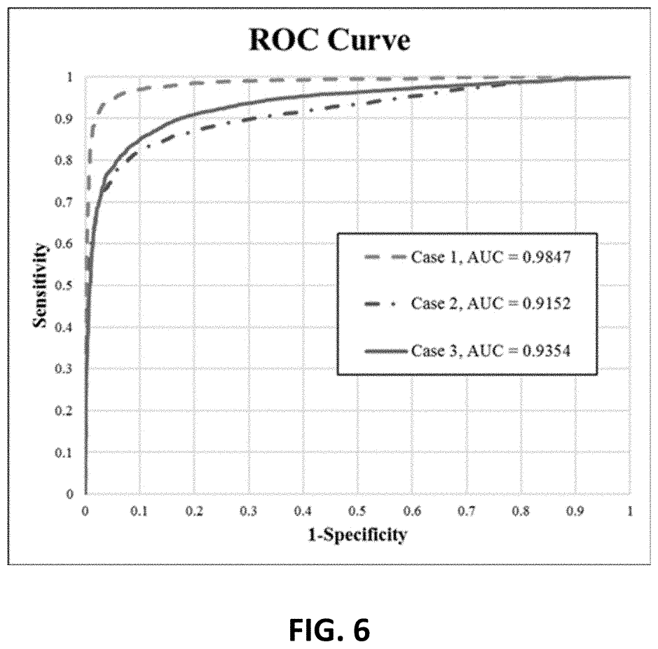

In one embodiment (e.g., Case 1 of FIG. 6), the system considers only borders (e.g., automatically determined of a training set of images) rated as 0 (e.g., as failing) and 2 (e.g., as success) to build a classifier model. For example, a total of 7,649 borders may be selected from the 12,452 borders obtained from the training set, in which 4,032 are good borders (rated as 2), and 3,617 are bad borders (rated as 0). The remaining 4,803 borders are acceptable borders (rated as 1) acceptable for melanoma detection but are not considered by the system, according to the embodiment. The system of Case 1 may be used to diagnose, examine, or process a testing set of images, where only borders rated as 0 and 2 are considered in calculating a rate of success, according to the embodiment. The system of Case 1 may be trained by considering Exact borders (e.g., borders rated as 2) as good borders and Failing borders (e.g., borders rated as 0) as bad borders to determine good (e.g., borders rated as 2) and bad borders (e.g., borders rated as 0).

In another embodiment (e.g., Case 2 of FIG. 6), the system builds a classifier model substantially similar or identical to the classifier model of Case 1, considering only borders rated as 0 and 2 from the training set to build the model and leaving borders rated as 1 unused. The system of Case 2 may be used to diagnose, examine, or process a testing set of images, where not only borders rated as 0 and 2 are considered in calculating a rate of success, borders rated as 1 are considered (e.g., as successful borders) as well. The system of Case 1 may be trained by only good (e.g., borders rated as 2) and bad (e.g., borders rated as 0) borders to determine only good and bad borders. The system of Case 2 may be trained by considering Exact borders (e.g., borders rated as 2) as good borders and Failing borders (e.g., borders rated as 0) as bad borders to determine good (e.g., borders rated as 2 and 1) and bad borders (e.g., borders rated as 0).

In another embodiment (e.g., Case 3 of FIG. 6), the system considers both borders (e.g., automatically determined of a training set of images) rated as 1 and borders rated as 2 as successful borders, and borders rated as 0 as failing borders to build the system's classifier model. The system of Case 3 may be used to diagnose, examine, or process a testing set of images, where only borders rated as 1 and 2 are considered as successful borders and borders rated as 0 are considered as failing borders, in calculating a rate of success, according to the embodiment. The system of Case 3 may be trained by considering Exact borders (e.g., borders rated as 2) and Approximate borders (e.g., borders rated as 1) as good borders and Failing borders (e.g., borders rated as 0) as bad borders to determine good (e.g., borders rated as 2 and 1) and bad borders (e.g., borders rated as 0).

E. Classifier Implementation

In various embodiments, the system uses a random forests classifier to select lesion borders. In some embodiments, the random forests classifier is an ensemble tree classifier that constructs a forest of classification trees from sample data subsets. In certain embodiments, the forest of the random forests classifier is constructed by having each tree built via randomly selecting training set data. In some embodiments, a different subset of training data is used for each tree to develop a decision tree model and the remaining training data is used to test the accuracy of the model. In some embodiments, the system is configured to determine a split condition for each node in the tree, where a subset of predictor variables may be randomly selected, which may reduce error due to reduced correlation of trees. In some embodiments, the classifier is implemented using the cran.R statistical package, and may have default values of B=500 trees where the entire data set is used for sampling and samples are used with replacement.

Example of Implementation of Classifying System and/or Method

A. Classifier Model

In some embodiments, a regression procedure generates a classifier model based on border features of the training set images. The model may then be implemented for a testing set of images where the best borders are selected by choosing the maximum predicted probability among all methods (e.g., algorithms). FIG. 6 shows a Receiver Operating Characteristic (ROC) curve for subjective model for Case 1, Case 2, and Case 3 using a random forests border classifier, in accordance with embodiments of the disclosure. The ROC is constructed for the subjective border metric model Case 1, Case 2, and Case 3. The area under the ROC curve (AUC) is 0.9847, 0.9152, 0.9354 for case 1, Case 2 and Case 3, respectively. As illustrated, Case 3, which considers borders rated as 1 (e.g., approximate borders) in building its classifier model, shows improved results (e.g., by 2.02%) over Case 2. AUC of Case 1 is artificially high, as Case 1 excludes the intermediate borders that are neither excellent or failing (e.g., borders rated as 1).

B. Border Selection Process

In some embodiments, the system calculates a feature vector, X_{Z}^{I}, for each image, I (e.g., of the training set of images and/or of the testing set of images), such as for all border choices available (e.g., the 13 borders determined by the 13 algorithms). In certain embodiments, the system calculates a random forests probability value, [symbol] , using a subset of feature, X_{Z}^{I}, for each border. In various embodiments, the system then chooses a border option z that yields maximum \hat{f}_{Z} (x). This procedure may be carried out as follows:

$$\begin{matrix}L {B}_{b e s t} ( I ) = {arg max}_{z} \hat{{f}_{z}} ( x ) where x ⋐ {X}_{z}^{I} & ( 18 ) \\ \hat{{f}_{z}} ( x ) = \frac{1}{B} {\sum }_{b = 1}^{B = 500} {f}_{b} ( x ) where {f}_{b} defines a tree & ( 19 )\end{matrix}$$

C. Border Analysis

In some embodiments, an accuracy (e.g., overall accuracy) of a system and/or a classifier model may be examined via a selection process of a testing set of images (e.g., 802 images of lesions). For example, the system may choose a best border from the automatically generated borders generated by the system, for each image. Once a best border is chosen by the system, a manual rating of 1, 2, or 3 may then be assigned to the best border (e.g., by a specialist), wherein a rating of 1 and/or 2 represent a successfully classified border of the system. In various embodiments, the accuracy of a system is increased or maximized (e.g., about 90%) by adapting a model building process and/or model testing process similar to or identical to the processes described for the system of Case 3. For example, the accuracy of a system similar to Case 1 may be 73.16% (e.g., with 586 grade-2 borders and 215 grade-0 borders); the accuracy of a system similar to Case 2 may be 88.78% (e.g., with 712 grade-2 or grade-1 borders and 89 grade-0 borders); and the accuracy of a system similar to Case 3 may be 89.78% (e.g., with 720 grade-2 or grade-1 borders and 81 grade-0 borders).

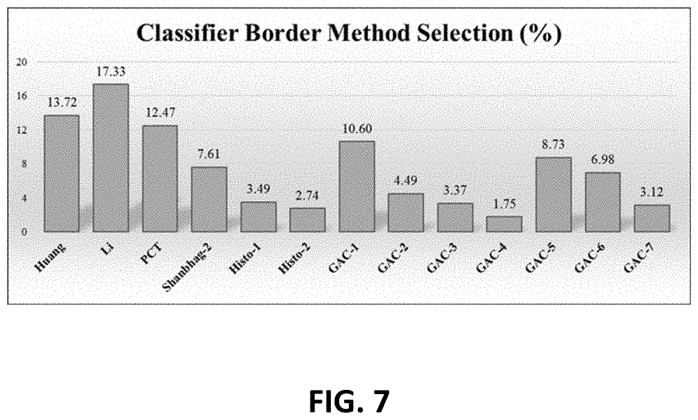

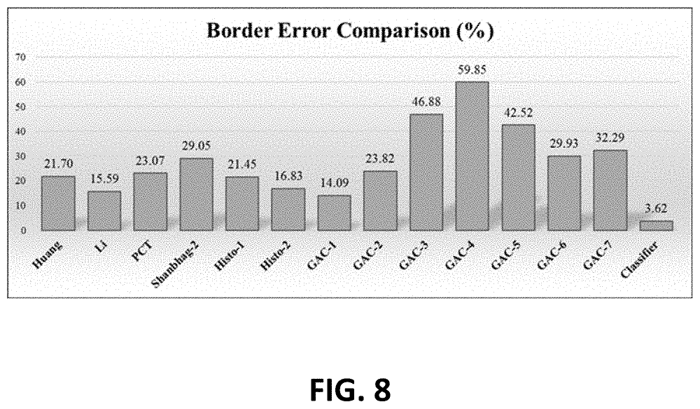

FIG. 7 is a bar graph depicting classifier border method selection frequency, in accordance with embodiments of the disclosure. FIG. 8 is a bar graph depicting border error comparison, in accordance with embodiments of the disclosure. As illustrated, border error of the classifier model, in accordance with various embodiments, may be below 5%, such as 3.62%, which is a 74.3% reduction in error rate compared to the best single-algorithm-based classifier model (i.e., GAC-1 with an error rate of 14.09%) considered for comparison purposes.

In some embodiments, the described system and method provide an improved automatic border detection by using multiple color features in five regions for each candidate border to assess border quality. In various embodiments, the system uses geometric features, such as via six measures that define candidate border quality to assess border size, centrality and compactness. The system may be more accurate with lesion borders that are more central, larger, and/or more compact. The system may increase accuracy by implementing one or more algorithms that are conventionally used infrequently (e.g., for uncommon lesions), such as GAC-4 and GAC-7, to determine the best border. In some embodiments, the system is configured to choose a best border of a lesion image independent of lesion size, shape, and contrast. In some embodiments, the system implements a subjective border grading system, such as a grading system based on the premise that borders need be just “good enough” to allow a correct diagnosis. As described, the accuracy of a system is increased or maximized (e.g., about 90%) by adapting a model building process and/or model testing process similar to or identical to the processes described for the system of Case 3.

In some embodiments, the instant disclosure describes a classifier for automatic dermoscopy image lesion border selection. The classifier model may be considered to select a good-enough lesion border from multiple lesion segmentation algorithms. In certain embodiments, a classifier of the instant disclosure achieves significant (e.g., over 70%, such as 74.3%) reduction in error rate (e.g., compared to conventional one-algorithm segmentation techniques) by having an automatic border error rate below 5%, such as 3.62%.

In some embodiments, the system is configured to calculate features representing good-enough borders, wherein the lesion segmentation and feature generation for classification are both fully automatic. Some lesion borders rated by specialists (e.g., dermatologists) may be fed back to the system to supervise learning and model creation.

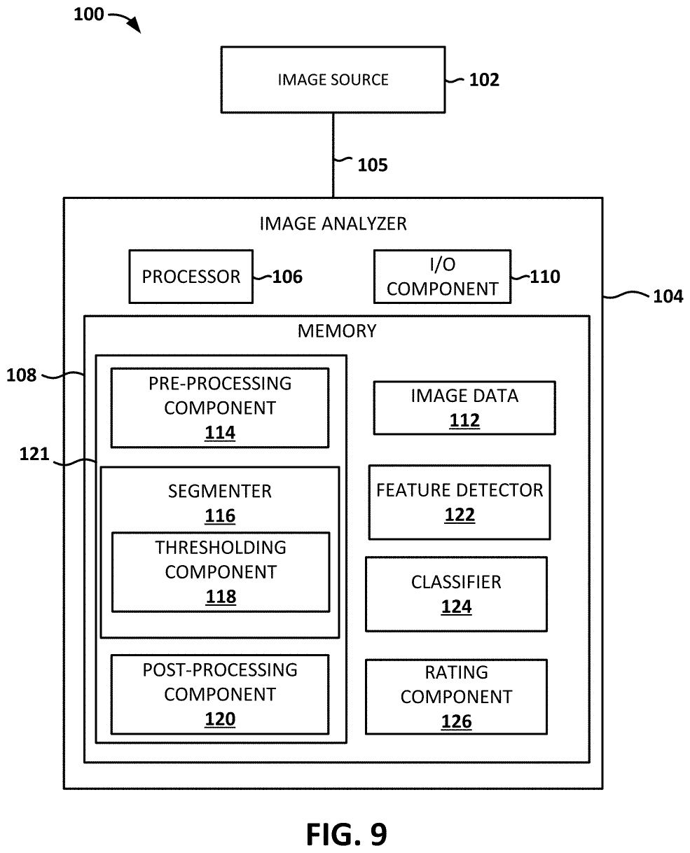

FIG. 9 depicts an illustrative digital dermoscopy system 100 in accordance with embodiments of the disclosure. The digital dermoscopy system 100 includes an image source 102 that is communicably coupled to an image analyzer 104. In some embodiments, the image analyzer 104 receives image data 112 from the image source 102 and analyzes the image data 112 to facilitate diagnosis of a skin affliction such as, for example, basal cell carcinoma (BCC), squamous cell carcinoma (SCC), or melanoma. Exemplary images include, but are not limited to, digital photographs, digital image files from medical imaging, machine vision image files, and/or the like. In embodiments, for example, the image source 102 may include a digital camera with an add-on device for 10-power magnification, and/or any other device with magnification within the range of 8-30 power. These devices may include, but are not limited to, the Canfield Epilight, Canfield Imaging Systems, Fairfield, N.J.; the 3Gen DermLite II Pro, 3Gen LLC, Dana Point, Calif.; the Heine Dermaphot, Heine Dermaphot Optics, Heine Ltd, Herrsching, Germany; and/or LED rings (3Gen Imaging, Dana Point, Calif., FotoFinder Teachscreen Software GmbH, Bad Birnbach, Germany). In embodiments, the image source 102 may be a computing device having a memory in which the image is stored.

As shown in FIG. 9, the image source 102 may be communicably coupled to the image analyzer 104 by a communication link 105. In embodiments, the image source 102 communicates an image over the communication link 105. In embodiments, the communication link 105 may be, or include, a wired communication link such as, for example, a USB link, a proprietary wired protocol, and/or the like. The communication link 105 may be, or include, a wireless communication link such as, for example, a short-range radio link, such as Bluetooth, IEEE 802.11, a proprietary wireless protocol, and/or the like. In embodiments, for example, the communication link 105 may utilize Bluetooth Low Energy radio (Bluetooth 4.1), or a similar protocol, and may utilize an operating frequency in the range of 2.40 to 2.48 GHz.

The term “communication link” may refer to an ability to communicate some type of information in at least one direction between at least two devices, and should not be understood to be limited to a direct, persistent, or otherwise limited communication channel. That is, according to embodiments, the communication link 105 may be a persistent communication link, an intermittent communication link, an ad-hoc communication link, and/or the like. The communication link 105 may refer to direct communications between the image source 102 and the image analyzer 104, and/or indirect communications that travel between the image source 102 and the image analyzer 104 via at least one other device (e.g., a repeater, router, hub, and/or the like). The communication link 105 may facilitate uni-directional and/or bi-directional communication between the image source 102 and the image analyzer 104. In embodiments, the communication link 105 is, includes, or is included in a wired network, a wireless network, or a combination of wired and wireless networks. Illustrative networks include any number of different types of communication networks such as, a short messaging service (SMS), a local area network (LAN), a wireless LAN (WLAN), a wide area network (WAN), the Internet, a peer-to-peer (P2P) network, or other suitable networks. The network may include a combination of multiple networks. In embodiments, for example, the image analyzer 104 may be accessible via the Internet (e.g., the image analyzer 104 may facilitate a web-based image analysis service), and a user may transmit an image, via the image source 102, to the image analyzer 104 for diagnostic services.

As shown in FIG. 9, the image analyzer 104 is implemented on a computing device that includes a processor 106, a memory 108, and an input/output (I/O) device 110. Although the image analyzer 104 is referred to herein in the singular, the image analyzer 104 may be implemented in multiple instances, distributed across multiple computing devices, instantiated within multiple virtual machines, and/or the like. In embodiments, the processor 106 executes various program components stored in the memory 108, which may facilitate analyzing the image 112. In embodiments, the processor 106 may be, or include, one processor or multiple processors. In embodiments, the I/O component 110 may be, or include, one I/O component or multiple I/O components and may be, or include, any number of different types of devices such as, for example, a monitor, a keyboard, a printer, a disk drive, a universal serial bus (USB) port, a speaker, pointer device, a trackball, a button, a switch, a touch screen, and/or the like. Alternatively, or additionally, the I/O component 110 may include software and/or firmware and may include a communication component configured to facilitate communication via the communication link 105, and/or the like.

According to embodiments, as indicated above, various components of the digital dermoscopy system 100, illustrated in FIG. 9, may be implemented on one or more computing devices. A computing device may include any type of computing device suitable for implementing embodiments of the invention. Examples of computing devices include specialized computing devices or general-purpose computing devices such as “workstations,” “servers,” “laptops,” “desktops,” “tablet computers,” “hand-held devices,” and the like, all of which are contemplated within the scope of FIG. 9 with reference to various components of the digital dermoscopy system 100. For example, according to embodiments, the image analyzer 104 (and/or the image source 102) may be, or include, a general purpose computing device (e.g., a desktop computer, a laptop, a mobile device, and/or the like), a specially-designed computing device (e.g., a dedicated video encoding device), and/or the like. Additionally, although not illustrated herein, the image source 102 may include any combination of components described herein with reference to the image analyzer 104, components not shown or described, and/or combinations of these.

In embodiments, a computing device includes a bus that, directly and/or indirectly, couples the following devices: a processor (e.g., the processor 106), a memory (e.g., the memory 108), an input/output (I/O) port, an I/O component (e.g., the I/O component 110), and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, memory (e.g., the memory 108) includes computer-readable media in the form of volatile and/or nonvolatile memory and may be removable, non-removable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; or any other medium that can be used to store information and can be accessed by a computing device such as, for example, quantum state memory, and the like. In embodiments, the memory (e.g., the memory 108) stores computer-executable instructions for causing the processor (e.g., the processor 106) to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a pre-processing component 114, a segmenter 116, a thresholding component 118 (e.g., as part of the segmenter 116), a post-processing component 120, a feature detector 122, a classifier 124, and/or a rating component 126. Program components may be programmed using any number of different programming environments, including various languages, development kits, frameworks, and/or the like. Some or all of the functionality contemplated herein may also, or alternatively, be implemented in hardware and/or firmware.

In embodiments, the pre-processing component 114 may be configured to pre-process (e.g., when executed by processor 106) an image 112 for segmentation. The pre-processing component 114 may be configured to detect and remove noises from the image such as, for example, portions of the image 112 that represent hairs, ruler markings, dark corners and/or the like. In embodiments, the pre-processing component 114 may use any number of different techniques for removing noise such as, for example, by applying an adaptive threshold for grayscale morphological closing, using an area opening filter, and applying noise removal strategies. Illustrative hair-removal techniques, among other techniques for detection of dermoscopy features, are described in U.S. Pat. No. 7,689,016, filed May 30, 2006, by William V. Stoecker et al., and entitled “AUTOMATIC DETECTION OF CRITICAL DERMOSCOPY FEATURES FOR MALIGNANT MELANOMA DIAGNOSIS,” the entirety of which is hereby incorporated herein by reference for all purposes.

In embodiments, the segmenter 116 may be configured to segment (e.g., when executed by processor 106) the pre-processed image into a number of segments, such as defined by a lesion mask, and the post-processing component 120 may further refine the segmentation to facilitate more accurate classification of BCC and/or other types of skin lesions, including but not limited to SCC and melanoma. The segments may include, for example, objects, groups, slices, tiles, and/or the like. The segmenter 116 may employ any number of various automatic image segmentation methods known in the field. In embodiments, the segmenter 116 may use image color and corresponding gradients to subdivide an image into segments that have similar color and texture. Examples of image segmentation techniques include gradient vector flow (GVF) contours, watershed segmentation, statistical region merging (SRM), and geodesic active contours (GAC).

In embodiments, the segmenter 116 may include a thresholding component 118 that performs (e.g., when executed by processor 106) one or more thresholding algorithms in addition to, or in lieu of one or more other segmentation techniques such as those listed above. In embodiments where the segmenter 116 employs more than one segmentation technique, the segmenter may instantiate a classifier or other decision algorithm to determine which result to adopt, to ascertain a result that is a combination of results obtained from the multiple segmentation techniques, and/or the like. In embodiments, the segmenter 116 may utilize machine-learning techniques to train algorithms to identify appropriate segmentation techniques to select a technique based on characteristics of an image, results from pre-processing, and/or the like.

In embodiments, for example, the thresholding component 118 may utilize a contour-generating algorithm such as, for example, geodesic a ctive contour (GAC) (e.g., as in GAC-1, GAC-2, GAC-3, GAC-4, GAC-5, GAC-6, and GAC-7), histogram thresholding in two color planes (e.g., as in Histo-1 and Histo-2), and histogram thresholding via entropy and fuzzy logic techniques (e.g., as in Huang, Li, Shanbhag-2, and PCT).

In certain embodiments, one or more of the pre-processing component 114, segmenter 116, thresholding component 118, and the post-processing component may be combined into or replaced by a border generator 121. In some embodiments, the border generator 121 is configured to (e.g., when executed by processor 106) process an image (e.g., image data 112) to automatically generate a plurality of borders based on a plurality of segmentation algorithms. For example, each of the plurality of borders is generated based on a different one of the plurality of segmentation algorithms.

As is further shown in FIG. 9, and mentioned above, the image analyzer 104 further includes a feature detector 122. The feature detector 122 may be used to detect (e.g., when executed by processor 106) one or more features in a segmented image. In embodiments, the feature detector 122 may represent more than one feature detector. The feature detector 122 may include any number of different types of feature detectors, implementations of feature detection algorithms, and/or the like.

In embodiments, the feature detector 122 is configured to (e.g., when executed by processor 106) detect one or more morphological features and/or one or more color features. In some embodiments, detecting the morphological features includes detecting centroid x and y locations, centroid distance, lesion perimeter, lesion area, scaled centroid distance, compactness, size, and/or size ratio. In some embodiments detecting color features includes detecting color features in the inside lesion area, the outside lesion area, the outer rim area, the inner rim area, and/or the overlapping area.

As is also shown in FIG. 9, the image analyzer 104 includes a classifier 124. The classifier 124 may be configured to receive input information (e.g., from the feature detector 122 and/or the post-processing component 120) and produce output (e.g., when executed by processor 106) that may include one or more classifications. In embodiments, the classifier may be a binary classifier and/or a non-binary classifier. The classifier may include any number of different types of classifiers such as, for example, a support vector machine (SVM), an extreme learning machine (ELM), a neural network, a convolutional neural network, logistic regression, a kernel-based perceptron, a k-NN classifier, a random forests classifier, and/or the like. The classifier 124 may be used to classify a lesion captured in an image as a BCC, an SCC, a melanoma, and/or the like. In some embodiments, a classifier 124 may be referred to as a classifier model.

In various embodiments, the classifier 124 is configured to generate or assign (e.g., when executed by processor 106) a classification to each of the plurality of borders automatically generated by the border generator 121. The classification may include a border rating (e.g., Exact, Approximate, or Failing) and/or a border score (e.g., 2, 1, 0). In certain embodiments, each classification is assigned based on one or more features detected by the feature detector 122. In various embodiments, the image analyzer 104 is configured to select a best border from the plurality of borders automatically generated (e.g., by the border generator 121). In some embodiments, the best border is selected based on the classification (e.g., border rating and/or border score) assigned to each border (e.g., by the classifier 124) and/or based on the one or more features detected by the feature detector 122.

In various embodiments, the image analyzer 104 includes a rating component 126. The rating component 126 may be configured to receive rating information for an automatically generated border (e.g., generated by the classifier 124). For example, the rating information includes a border rating (e.g., Exact, Approximate, or Failing) and/or a border score (e.g., 2, 1, 0), which may be given, assigned, or provided (manually) by a specialist (e.g., a dermatologist). In some embodiments, the system 100 is configured to use the rating information received by the rating component 126 to train, build, and/or improve the system's classifier model (e.g., classifier 124). In some embodiments, the rating component 126 is part of the classifier 124.

The illustrative digital dermoscopy system 100 shown in FIG. 9 is not intended to suggest any limitation as to the scope of use or functionality of embodiments of the present disclosure. Neither should the illustrative digital dermoscopy system 100 be interpreted as having any dependency or requirement related to any single component or combination of components illustrated therein. Additionally, any one or more of the components depicted in FIG. 9 may be, in embodiments, integrated with various ones of the other components depicted therein (and/or components not illustrated), all of which are considered to be within the ambit of the presently disclosed subject matter.

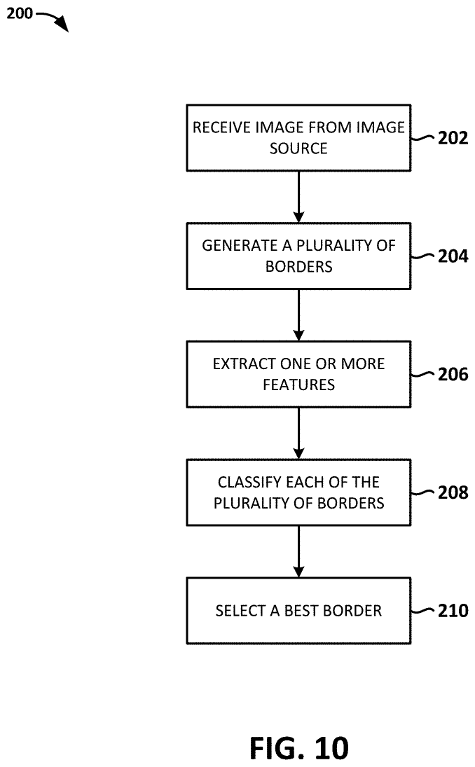

FIG. 10 is a flow diagram depicting an illustrative method 200 of border classification using dermoscopy images, in accordance with embodiments of the disclosure. Embodiments of the method 200 may be performed by aspects of the illustrative digital dermoscopy system 100 depicted in FIG. 9. As shown in FIG. 10, embodiments of the method 200 include receiving an image from image source (block 202). As described above, the image source 202 may include a digital imaging device such as, for example, a digital camera having an adapter that facilitates magnification.

Embodiments of the method 200 further include generating a plurality of borders (e.g., lesion borders) (block 204), such as automatically generating the plurality of borders. In various embodiments, generating the plurality of borders (block 204) includes processing the image received at step 202. For example, generating the plurality of borers (block 204) may include pre-processing the image, which may include, for example, detecting and removing noises from the image such as, for example, portions of the image that represent hairs, ruler markings, dark corners and/or the like. In some embodiments, generating the plurality of borders (block 204) includes segmenting the image, such as using one or more segmentation methods, such as using one of a plurality of segmentation methods. According to embodiments, the plurality of segmentation methods may include, for example, the geodesic active contour (GAC) method (e.g., as in GAC-1, GAC-2, GAC-3, GAC-4, GAC-5, GAC-6, and GAC-7), the histogram thresholding method based on color planes (e.g., as in Histo-1 and Histo-2), and modified histogram thresholding via entropy and fuzzy logic methods (e.g., as in Huang, Li, Shanbhag-2, and PCT). In various embodiments, generating the plurality of borders (block 204) may be performed by the border generator 121.

As shown in FIG. 10, embodiments of the method 200 also include extracting one or more features (block 206), such as using the feature detector 122. In various embodiments, extracting one or more features includes extracting one or more morphological features and/or one or more color features. In certain embodiments, detecting the morphological features includes detecting centroid x and y locations, centroid distance, lesion perimeter, lesion area, scaled centroid distance, compactness, size, and/or size ratio. In some embodiments, detecting color features includes detecting color features in the inside lesion area, the outside lesion area, the outer rim area, the inner rim area, and/or the overlapping area.

As shown in FIG. 10, embodiments of the method 200 also include classifying (e.g., using the classifier, or classifier model) each of the plurality of borders (block 208). In various embodiments, classifying each of the plurality of borders includes assigning a classification to each of the plurality of borders. In certain embodiments, the classification includes a border rating (e.g., Exact, Approximate, or Failing) and/or a border score (e.g., 2, 1, 0). In certain embodiments, each classification is assigned based on the one or more features extracted at step 206.

As shown in FIG. 10, embodiments of the method 200 also include selecting a best border (e.g., using the image analyzer) from the plurality of borders (block 210).

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Isodata and Otsu techniques may be substituted for Li and Shanbhag techniques, respectively. Further, methods which can successfully segment BCC can be applied to any skin cancer or benign lesion. Thus descriptions of the method which recited BCC specifically are to be regarded as illustrative, as they can apply to and be extended to any skin cancer. Accordingly, the scope of the present disclosure is intended to embrace all such alternatives, modifications, and variations as fall within the scope of the claims, together with all equivalents thereof.

We claim:

1. A classifying system for classifying a lesion border of a dermoscopy image, the system comprising:
an image analyzer having at least one processor that instantiates at least one component stored in a memory, the at least one component comprising:
a border generator configured to automatically generate a plurality of borders based on a plurality of segmentation algorithms, wherein each of the plurality of borders is generated based on a different one of the plurality of segmentation algorithms;
a feature detector configured to detect one or more features on the dermoscopy image for each of the plurality of borders; and
a classifier configured to assign a classification to each of the plurality of borders based on the one or more features detected by the feature detector;
wherein the image analyzer is configured to select a best border from the plurality of borders based on the classification assigned by the classifier.

2. The system of claim 1, wherein the plurality of segmentation algorithms includes at least one of geodesic active contour, histogram thresholding, and minimum cross entropy thresholding.

3. The system of claim 1, wherein the border generator includes a pre-processing component configured to detect and remove dark corners of the image.

4. The system of claim 1, wherein the feature detector is configured to detect one or more morphological features.

5. The system of claim 4, wherein the one or more morphological features include at least one or centroid x and y locations, centroid distance, lesion perimeter, lesion area, scaled centroid distance, compactness, size, and size ratio.

6. The system of claim 1, wherein the feature detector is configured to detect one or more color features.

7. The system of claim 6, wherein the feature detector is configured to detect the one or more color features at one or more of an inside lesion area, an outside lesion area, an outer rim area, an inner rim area, and an overlapping area.

8. The system of claim 1, wherein the classification assigned by the classifier includes at least one of a border rating and a border score.

9. The system of claim 1, wherein the classification assigned by the classifier is one of a first classification corresponding to a good border, a second classification corresponding to an approximate border, and a third classification corresponding to a failing border.

10. The system of claim 1, wherein the classifier is configured to be trainable to improve at least one of border generation accuracy and speed.

11. The system of claim 10, wherein the classifier is configured to accept a manual border grade assigned to an automatically generated border of a training image.

12. The system of claim 11, wherein the classifier is configured to accept a first manual border grade and a second manual border grade as success and a third manual border grade as failure, wherein the first manual border grade corresponds to a good border, wherein the second manual border grade corresponds to an approximal border, and wherein the third manual border grade corresponds to a failing border.

13. A method for classifying lesion border of dermoscopy images using a classifying system, the method comprising:
receiving image from an image source;
generating a plurality of borders based on a plurality of segmentation methods;
extracting one or more features of the image for each of the plurality of borders;
classifying each of the plurality of borders by assigning a classification to each of the plurality of borders based on the one or more features extracted; and
selecting a best border from the plurality of borders based on the classification.

14. The method of claim 13, wherein the plurality of segmentation methods include at least one of geodesic active contour, histogram thresholding, and minimum cross entropy thresholding.

15. The method of claim 13, wherein generating the plurality of borders includes processing the image to remove dark corners.

16. The method of claim 13, wherein extracting one or more features includes extracting one or more morphological features.

17. The system of claim 13, wherein extracting one or more features includes extracting one or more color features.

18. The system of claim 17, wherein extracting one or more features includes extracting one or more color features at one or more of an inside lesion area, an outside lesion area, an outer rim area, an inner rim area, and an overlapping area.

19. The system of claim 13, wherein classifying each of the plurality of borders includes assigning one of a first classification corresponding to a good border, a second classification corresponding to an approximate border, and a third classification corresponding to a failing border.

20. The system of claim 13, further includes training a classifier by accepting a manual border grade assigned to an automatically generated border of a training image.
